(19) United States
(12) Patent Application Publication
(10) Pub. No.: US 2014/0187156 A1
(43) Pub. Date: Jul. 3, 2014

(54) Mobile Wireless Media Head Unit Player

(71) Applicants: Derrick Bane, San Clemente, CA (US); Virlen Bane, San Clemente, CA (US)

(72) Inventors: Derrick Bane, San Clemente, CA (US); Virlen Bane, San Clemente, CA (US)

(21) Appl. No.: 14/073,227

(22) Filed: Nov. 6, 2013

Related U.S. Application Data
(60) Provisional application No. 61/746,630, filed on Dec. 28, 2012.

(51) Int. Cl. B60K 37/02

(52) U.S. Cl. CPC B60K 37/02
USPC 455/41.1; 455/557

(57) ABSTRACT

A head unit device is disclosed that allows users access to applications on their electronic devices while driving and incorporates the applications, such as a navigational system and music player into a vehicle's sound system. The head unit device comprises a housing component and an electronic device that is removably secured within the housing component. The housing component comprises a wireless networking device that communicates with the electronic device. The electronic device is inserted into the interior cavity such that a user can view and access the face of the electronic device. Furthermore, the housing component comprises a detachable faceplate with near-field communication (NFC) for communicating with the electronic device, and a wireless charging pad for charging the electronic device.

### CROSS-REFERENCE

This application claims priority from Provisional Patent Application Ser. No. 61/746,630 filed Dec. 28, 2012.

### BACKGROUND

Many, if not all vehicles are outfitted with a head unit and a sound system. In addition, many individuals use an after-market navigation system and/or their smart phone with their vehicle to drive to new locations. Furthermore, it can be a hassle and highly dangerous to shuffle between the different devices while driving. Cords running from the various devices can become tangled and can also get in the driver's way. Additionally, if individuals don't properly store the navigation system and/or smart phone device, other individuals can break into the vehicle and steal the expensive equipment. An effective solution is necessary.

The present invention replaces a vehicle's head unit display with an electronic device, such as a smart phone, and incorporates the electronic device and its applications, such as a navigational system and music player, into a vehicle's sound system. The head unit device also charges and connects the electronic device to a vehicle without having to deal with long, tangle-prone cords, and eliminates the dangers associated with holding onto a device or smart phone and using its navigational features while driving. The head unit device secures a smart phone or device in place, preventing it from falling between a vehicle's seats or onto the floor during stop-and-go traffic.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a head unit device that allows users access to the applications on their smart phone or other electronic device while driving and incorporates the applications, such as a navigational system and music player into a vehicle's sound system. The head unit device comprises a housing component and an electronic device that is removably secured within the housing component. The housing component comprises a wireless networking device that communicates with the electronic device to allow a user to receive telephone calls, data, navigational data (or information), voice, and music from the electronic device. The housing component is typically secured to an interior surface of a vehicle, and comprises an interior cavity for retaining the electronic device.

The electronic device is inserted into the interior cavity such that a user can view and access the face of the electronic device. Furthermore, the housing component comprises a U-shaped detachable faceplate for securing the electronic device within the interior cavity of the housing component and a wireless charging pad for charging the electronic device. The detachable faceplate comprises near-field communication (NFC) for communicating with the electronic device. The U-shaped faceplate is secured within the interior cavity of the housing component via wedging one side into the housing component and securing the other side via screws. This allows for the accommodation of different sized electronic devices.

In a preferred embodiment, the wireless charging pad comprises gliding tracks, or other movable means to allow the charging pad to move in and out of the interior cavity of the housing component. Additionally, the housing component comprises a built-in AM/FM, HD radio, CD player, MP3 player, four channel amplifier, push buttons, turn knobs, auxiliary inputs/outputs, pre-amp out, front-rear sub woofer, USB ports, microphone, noise cancellation controls, etc.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the head unit device in accordance with the disclosed architecture.

FIG. 2 illustrates a perspective view of the head unit device with the charge pad in accordance with the disclosed architecture.

FIG. 3 illustrates a perspective view of the head unit device with an electronic device secured therein in accordance with the disclosed architecture.

FIG. 4 illustrates a perspective view of the head unit device with an electronic device secured therein and turned on to show functionality in accordance with the disclosed architecture.

FIG. 5 illustrates a perspective view of the head unit device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention replaces a vehicle's head unit display with an electronic device, such as a smart phone, and incorporates the electronic device and its applications, such as a navigational system and music player, into a vehicle's sound system. The head unit device also charges and connects the electronic device to a vehicle without having to deal with long, tangle-prone cords, and eliminates the dangers associated with holding onto a device or smart phone and using its navigational features while driving. The head unit device secures a smart phone or device in place, preventing it from falling between a vehicle's seats or onto the floor during stop-and-go traffic. Anyone who utilizes their smart phone and separate navigational devices while driving may appreciate the convenience afforded by this device.

The disclosed head unit device comprises a housing component and an electronic device that is removably secured within the housing component. The housing component comprises a wireless networking device that communicates with the electronic device to allow a user to receive telephone calls, data, navigational data, voice, and music from the electronic device. The electronic device is inserted into the interior cavity such that a user can view and access the face of the electronic device. Furthermore, the housing component comprises a U-shaped detachable faceplate with near-field communication (NFC) for communicating with the electronic device, and a wireless charging pad for charging the electronic device. The detachable faceplate is secured via wedging one side into the housing component and securing the other side via screws. This allows for the accommodation of different sized electronic devices.

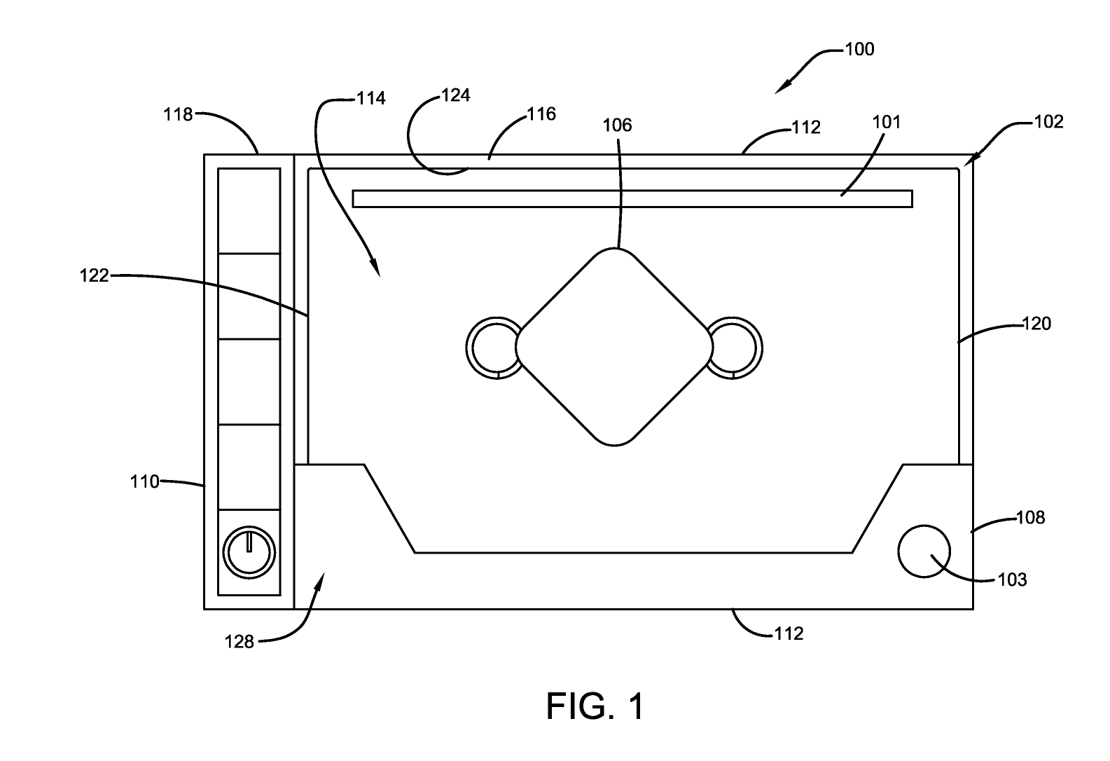

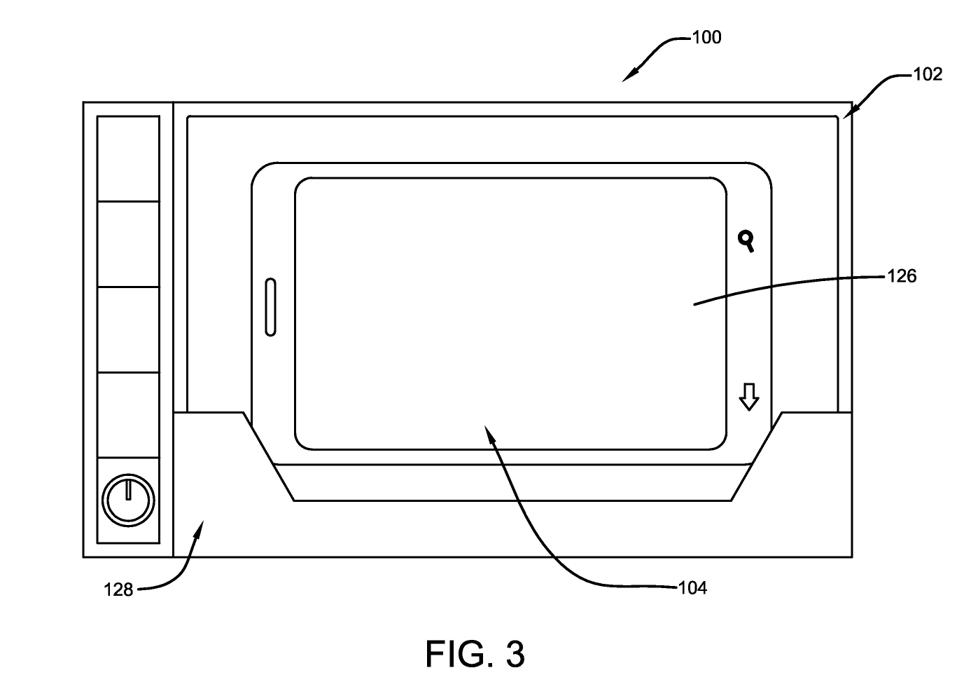

Referring initially to the drawings, FIGS. 1-4 illustrate the head unit device 100 that allows users access to the applications on their smart phone or other electronic device while driving and incorporates the applications, such as a navigational system and music player into a vehicle's sound system. The head unit device 100 comprises a housing component 102 and an electronic device 104 that is removably secured within the housing component 102 (as shown in FIG. 3). The housing component 102 comprises a wireless networking device 106 that communicates with the electronic device 104.

The housing component 102 comprises a first end 108, a second end 110, opposing sides 112, and an interior cavity 114. Typically, the housing component 102 is rectangular in shape, however any other suitable shape can be used as is known in the art without affecting the overall concept of the invention, as long as a desired electronic device 104 can be secured within the housing component 102. The housing component 102 would generally be constructed of heavy duty plastic, or metal, such as aluminum, steel, etc., though any other suitable material may be used to manufacture the housing component 102 as is known in the art without affecting the overall concept of the invention.

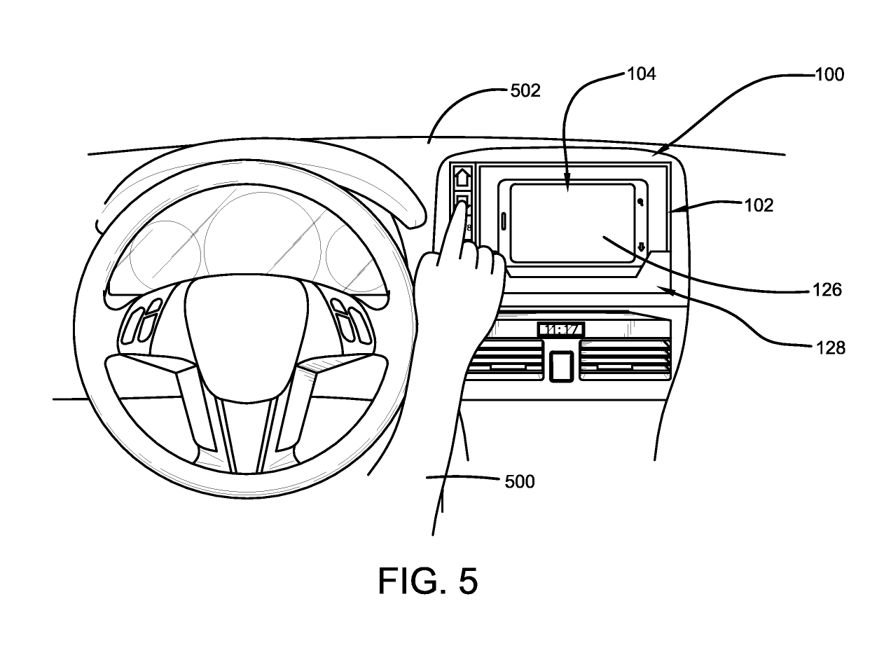

The housing component 102 can also comprise a variety of colors and designs to suit user and manufacturing preference. The housing component 102 is approximately between 2 and 10 inches long as measured from the first end 108 to the second end 110, and approximately between 3 and 8 inches wide as measured from opposing sides 112, and approximately between 0.01 and 0.1 inches thick as measured from a front surface 116 to a back surface 118. The housing component 102 is typically secured to an interior surface of a vehicle (as shown in FIG. 5), but can be secured to any suitable position on the vehicle as is known in the art.

The housing component 102 comprises an interior cavity 114 (or cut-out section) defined within the front surface 116 (or face) of the housing component 102 (as shown in FIG. 1). The interior cavity 114 comprises a first end 120, a second end 122, and opposing sides 124. The interior cavity 114 can be any suitable size as long as an electronic device 104 can be housed within. The electronic device 104 is removably secured within the interior cavity 114 of the housing component 102 via any suitable securing means as is known in the art, such as a snap fit, fasteners, etc. Thus, users can insert their electronic device 104 while driving, and then remove it for use outside the vehicle.

Specifically, the electronic device 104 is typically turned approximately 90 degrees from an upright position and inserted into the interior cavity 114 of the housing component 102 in a horizontal position, but can be inserted into the interior cavity 114 in any suitable position as is known in the art, such that a user can view and access the face 126 of the electronic device 104 while in the interior cavity 114 of the housing component 102. Further, any suitable electronic device 104 can be used as is known in the art such as a smart phone, an electronic tablet, and other similar electronic devices.

The housing component 102 comprises a wireless networking device 106 that wirelessly communicates with the electronic device 104 to allow a user to receive telephone calls, data, navigational data (or information), voice, camera data (i.e., can be wirelessly connected to the electronic device's camera and used as a back-up camera for the vehicle), and music from the electronic device 104. The wireless networking device 106 can be any suitable wireless networking device 106 as is known in the art, such as a USB adapter or a wireless router, or other high-speed amplifier (AMP) wireless networking device, that functions through Bluetooth® technology, NFC, or other existing wireless technology. The telephone calls, data, navigational information, voice, and/or music from the electronic device 104 can then be incorporated (or transferred) to the vehicle's sound system.

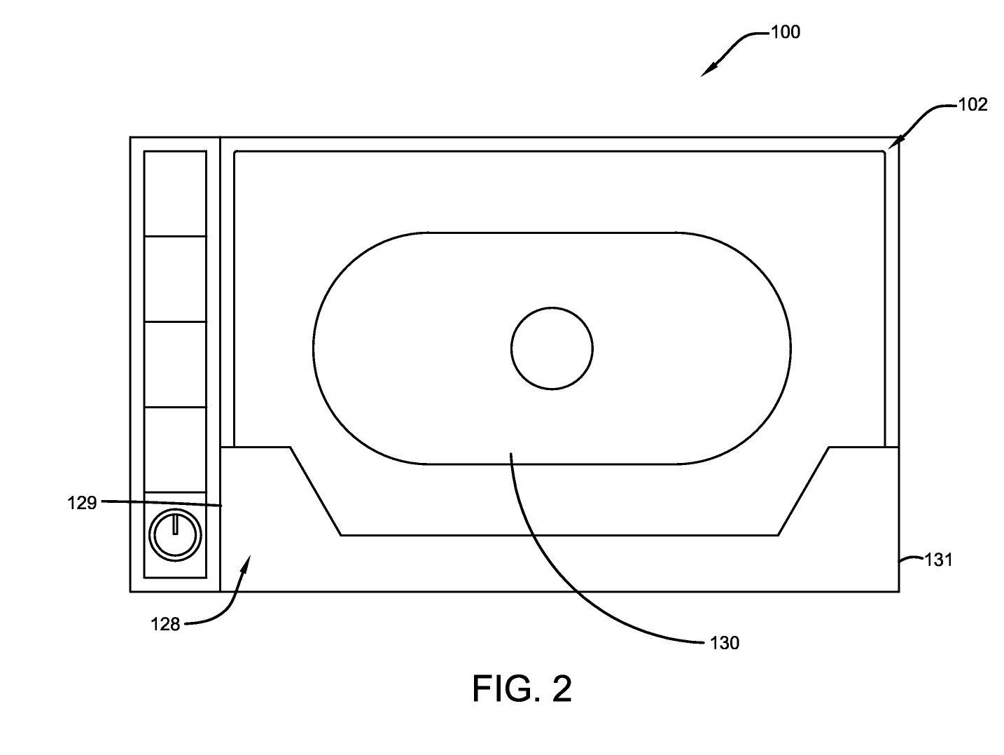

Furthermore, the housing component 102 comprises a U-shaped detachable faceplate 128 for securing the electronic device 104 within the interior cavity 114 of the housing component 102 (as shown in FIG. 2) and a wireless charging pad 130 for charging the electronic device. The detachable faceplate 128 comprises near-field communication (NFC) for communicating with the electronic device 104. The NFC-enabled detachable faceplate 128 allows for interaction with various electronic devices 104, such as smart phones and electronic tablets. The wireless charging pad 130 functions as a typical charging source as is known in the art, and contact with an electronic device 104 allows for charging of that device (or other after market attachments can be used to charge the electronic device 104 via the charging pad 130).

The detachable faceplate 128 is secured within the interior cavity 114 of the housing component 102 via wedging one side 129 into the housing component 102 and securing the other side 131 via any suitable securing means as is known in the art, such as fasteners, screws, glue, etc. This allows for the accommodation of different sized electronic devices 104 to be utilized and securely retained within the housing component 102.

Furthermore, the induction charging pad 130 can comprise gliding tracks, springs, or other movable means to allow the charging pad 130 to move in and out of the interior cavity 114 of the housing component 102 to accommodate different thicknesses and sizes of electronic devices 104.

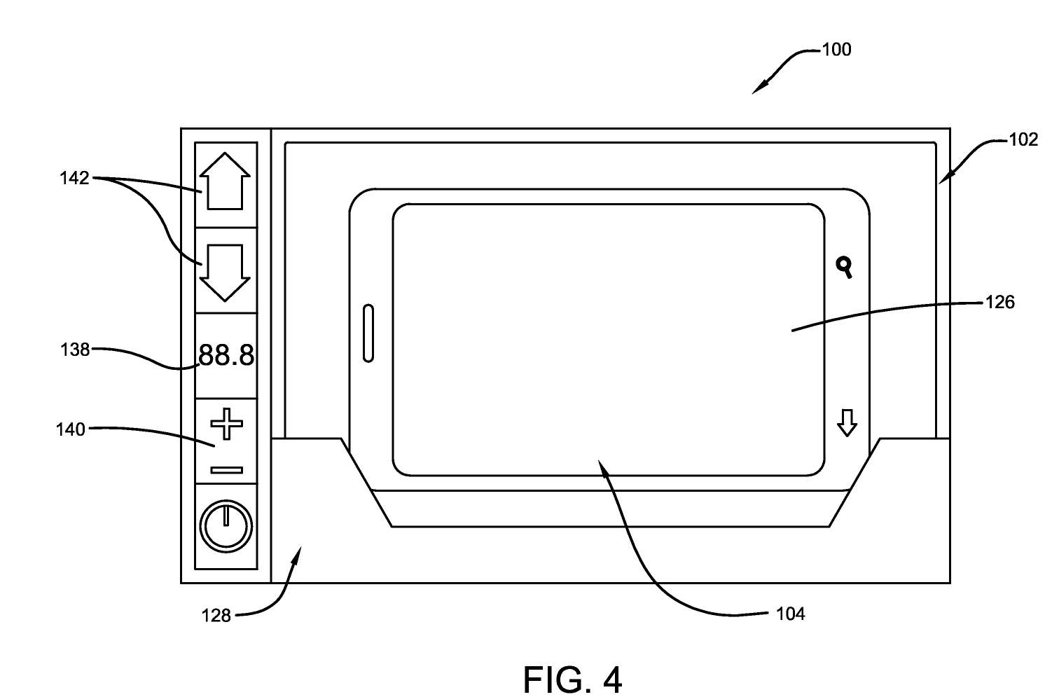

The housing component 102 further comprises a built-in AM/FM high-definition radio 138 or other suitable radio as is known in the art (as shown in FIG. 4). The AM/FM radio 138 functions as a typical prior art radio and allows a user to play music through the vehicle's sound system. The housing component 102 also comprises volume 140 and tuner 142 knobs to control the AM/FM high-definition radio 138, as well as other desired controls, such as a power switch, CD player 101, auxiliary inputs, and volume and tuner knobs to control AM/FM, HD Radio, Satellite Digital Audio Radio Service (SDARS), Digital Audio Radio Service (DARS), Bluetooth, Wi-Fi, Near Field Communication (NFC), Radio-Frequency Identification (RFID), Digital Signal Processor (DSP), MP3 player, four channel amplifier, push buttons, turn knobs, pre-amp out, front-rear sub woofer, USB inputs/outputs, microphone 103, noise cancellation, etc.

FIG. 5 illustrates the head unit device 100 in use. In operation, a user 500 would choose the size and/or type of electronic device 104 that meets their needs and/or wants, such as a smart phone or an electronic tablet. Further, the user 500 would secure the housing component 102 to a desired position within the interior of the vehicle 502. The user 500 would then insert the electronic device 104 within the interior cavity 114 of the housing component 102, securing it in place via the detachable faceplate 128.

Once secured within the interior cavity 114 of the housing component 102, the user 500 can then utilize the electronic device 104 normally, with the applications, such as the navigational system and music player being incorporated into the vehicle's 502 sound system, and allowing for hands-free use while driving. Thus, the head unit device 100 charges and connects an electronic device 104 to the vehicle 502 without having to deal with long, tangle-prone cords, and eliminates the dangers associated with holding onto an electronic device 104 and using its navigational features while driving.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A head unit device that incorporates an electronic device comprising:
a housing component comprising a first end, a second end, opposing sides, and an interior cavity;
an electronic device that is removably secured within the interior cavity of the housing component; and
wherein the housing component comprises a wireless networking device that communicates with the electronic device.

2. The head unit device of claim 1, wherein the housing component is secured to an interior surface of a vehicle.

3. The head unit device of claim 1, further comprising a detachable faceplate for securing the electronic device within the interior cavity of the housing component.

4. The head unit device of claim 3, wherein the detachable faceplate comprises a near-field communication (NFC) coil for communicating with the electronic device.

5. The head unit device of claim 3, wherein the housing component comprises a wireless charging pad for charging the electronic device.

6. The head unit device of claim 3, wherein the detachable faceplate is secured to the housing component.

7. The head unit device of claim 6, wherein the detachable faceplate is U-shaped.

8. The head unit device of claim 1, wherein the electronic device comprises at least one of a smart phone or an electronic tablet.

9. The head unit device of claim 1, wherein the housing component comprises a built-in AM/FM high-definition radio.

10. The head unit device of claim 9, wherein the housing component comprises volume and tuner knobs to control the AM/FM high-definition radio.

11. A head unit device that incorporates an electronic device comprising:
a housing component comprising a first end, a second end, opposing sides, and an interior cavity;
a smart phone that is removably secured within the interior cavity of the housing component; and
a detachable faceplate for securing the smart phone within the interior cavity of the housing component; and
wherein the detachable faceplate is U-shaped and secured to the housing component; and
wherein the housing component comprises a wireless networking device that communicates with the smart phone to allow a user to receive telephone calls, data, navigational data, voice, and music from the smart phone.

12. The head unit device of claim 11, wherein the detachable faceplate comprises a near-field communication (NFC) coil for communicating with the smart phone.

13. The head unit device of claim 11, wherein the housing component comprises a wireless charging pad for charging the smart phone.

14. The head unit device of claim 11, wherein the housing component is secured to an interior surface of a vehicle.

15. The head unit device of claim 11, wherein the housing component comprises a built-in AM/FM high-definition radio.

16. The head unit device of claim 15, wherein the housing component comprises volume and tuner knobs to control the AM/FM high-definition radio.

17. A head unit device that incorporates an electronic device comprising:
a housing component comprising a first end, a second end, opposing sides, and an interior cavity;
an electronic tablet that is removably secured within the interior cavity of the housing component; and
a detachable faceplate for securing the electronic tablet within the interior cavity of the housing component; and
a built-in AM/FM high-definition radio secured to the housing component;
wherein the detachable faceplate is U-shaped and secured to the housing component; and
wherein the housing component comprises a wireless networking device that communicates with the electronic tablet to allow a user to receive telephone calls, data, navigational data, voice, and music from the electronic tablet.

18. The head unit device of claim 17, wherein the housing component comprises a wireless charging pad for charging the electronic tablet.

19. The head unit device of claim 17, wherein the detachable faceplate comprises a near-field communication (NFC) coil for communicating with the electronic tablet.

20. The head unit device of claim 17, wherein the housing component is secured to an interior surface of a vehicle.
